(19) United States
(12) Patent Application Publication
(10) Pub. No.: US 2023/0097136 A1
(43) Pub. Date: Mar. 30, 2023

(54) System and Method for Monitoring Operation of a Heating System for a Space

(71) Applicant: Hubbell Incorporated, Shelton, CT (US)

(72) Inventor: Derek Hudson SCHACHT, Avon, CT (US)

(21) Appl. No.: 17/909,250

(22) PCT Filed: Feb. 23, 2021
(86) PCT No.: PCT/US2021/019237

§ 371 Date: Sep. 2, 2022

Related U.S. Application Data
(60) Provisional application No. 62/984,931, filed on Mar. 4, 2020.

(51) Int. Cl. F24D 5/02; F24D 19/10; F24H 9/20; G05B 23/02

(52) U.S. Cl. CPC F24D 5/02; F24D 19/1084; F24H 9/2085; G05B 23/0286; F24D 2220/042

(57) ABSTRACT

A collection of methods for monitoring the operation of a heating system configured to heat a space is provided. One method includes obtaining, by one or more computing devices, data from a fuel sensor for a period of time, the fuel sensor configured to detect an amount of fuel within a fuel supply for a furnace of the heating system. The method further includes determining, by the one or more computing devices, an adjustment to the operation of the heating system based, at least in part, on the data obtained from the fuel sensor. The method additionally includes adjusting, by the one or more computing devices, the operation of the heating system according to the adjustment.

### FIELD

The present disclosure relates generally to heating systems having a furnace and, more particularly, to a system and method for monitoring operation of the furnace.

### BACKGROUND

Heating systems having a furnace may be used to heat a space, such as the interior of a building. Heating systems may include a thermostat to control operation of the furnace. In such cases, the thermostat may call on the furnace to heat the space when a temperature for the space falls outside a range of acceptable values associated with a setpoint for the space. The furnace may then heat the space until the thermostat determines the temperature of the space is again within the range of acceptable values.

### SUMMARY

Aspects and advantages of embodiments of the present disclosure will be set forth in part in the following description, or may be learned from the description, or may be learned through practice of the embodiments.

In one illustrative variation, a method for monitoring the operation of a heating system configured to heat a space is provided. The method includes obtaining, by one or more computing devices, data from a fuel sensor for a period of time, the fuel sensor configured to detect an amount of fuel within a fuel supply for a furnace of the heating system. In addition, the method further includes determining, by the one or more computing devices, an adjustment to the operation of the heating system based, at least in part, on the data obtained from the fuel sensor. Furthermore, the method includes adjusting, by the one or more computing devices, the operation of the heating system according to the adjustment.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a schematic of a heating system for a space according to example embodiments of the present disclosure;

FIG. 2 depicts a block diagram of components of a furnace of a heating system according to example embodiments of the present disclosure;

FIG. 3 depicts a schematic of a system for monitoring operation of the heating system according to example embodiments of the present disclosure;

FIG. 4 depicts a graphical representation of a temperature for a plurality of zones of a space taken for a period of time according to example embodiments of the present disclosure;

FIG. 5 depicts a graphical representation of fuel consumption of a furnace for a period of time according to example embodiments of the present disclosure;

FIG. 6 depicts a flow diagram of a method for monitoring operation of a heating system according to example embodiments of the present disclosure;

FIG. 7 depicts another flow diagram of a method for monitoring operation of a heating system according to example embodiments of the present disclosure; and

FIG. 8 depicts a block diagram of components of a computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to a system for monitoring operation of a heating system for a space. The system may include a plurality of temperature sensors that are separate from a thermostat of the heating system. The plurality of temperature sensors may be dispersed throughout the space. For instance, each of the plurality of temperature sensors may be positioned at a different zone (e.g., story, room, etc.) of the space. In this manner, data obtained from the plurality of temperature sensors may indicate variations in a temperature of the different zones. The system may include a fuel sensor. The fuel sensor may be configured to detect an amount of fuel within a fuel supply (e.g., tank) configured to provide fuel that is burned by a furnace of the heating system to heat the space. As will be discussed below, the data obtained from the plurality of temperature sensors and the fuel sensor can be processed to determine whether operation of the heating system needs to be adjusted.

In some implementations, the system can include one or more computing devices configured to determine the amount of fuel remaining within the fuel supply based, at least in part, on the data obtained via the fuel sensor. For instance, in some implementations, the one or more computing devices can be configured to generate a notification when the amount of fuel remaining within the fuel supply is less than an threshold amount (e.g., about 25% full). The notification can, in some implementations, be at least one of an audible notification (e.g., automated phone call) and a visual notification (e.g., text message, email) provided to a user device associated with a user (e.g., homeowner, technician, etc.). In this manner, the notification prompts the user to perform a maintenance action (e.g., refill the fuel supply such that the amount of fuel within the full supply is greater than the threshold amount. It should be understood that the fuel sensor may include any suitable type of sensor operable to detect the amount of fuel in the tank. For instance, in some implementations, the fuel sensor can be an ultrasonic sensor.

In some implementations, the one or more computing devices can be configured to generate a graphical representation of a temperature at one or more zones (e.g., story, room, space, etc.) of the space for a period of time (e.g., about 12 hours) based, at least in part on the data obtained from the plurality of temperature sensors which, as discussed above, are dispersed throughout the space. Alternatively or additionally, the one or more computing devices may be configured to generate a graphical representation of fuel consumption of the furnace for the period of time based, at least in part, on the data (e.g., fuel level readings) obtained from the fuel sensor.

In some implementations, the one or more computing devices can be configured to determine an adjustment to the operation of the heating system based, at least in part, on the data obtained from the fuel sensor for the period of time. For instance, if the data obtained from the fuel sensor for the period of time indicates that the amount of fuel within the fuel supply is constantly decreasing, the one or more computing devices may be configured to determine that the operation of the heating system needs to be adjusted. In particular, the one or more computing devices may determine that the furnace needs to be shut down and one or more maintenance actions need to be performed on one or more components thereof.

In some implementations, the one or more computing devices can be configured to determine an adjustment to the operation of the heating system based, at least in part, on the data obtained from the fuel sensor for the period of time and the data obtained from one or more of the plurality of temperature sensors for the period of time. For instance, in some implementations, the data obtained from the fuel sensor may indicate that the amount of fuel within the fuel supply is constantly decreasing. However, the data obtained from the plurality of temperature sensors may indicate that the temperature of one or more zones within the space is not increasing as a result of the furnace heating the space. For instance, data obtained from a first temperature sensor positioned within a first zone (e.g., first story) of the space may indicate a temperature of the first zone is increasing (e.g., getting warmer). However, data obtained from a second temperature sensor positioned within a second zone (e.g., second story) of the space may indicate a temperature of the second zone is either staying the same (e.g., not increasing) or decreasing (e.g., getting cooler). In such instances, the adjustment can include performing a maintenance action on one or more components of the heating system.

In some implementations, the one or more computing devices can be configured to determine an adjustment to the operation of the heating system based, at least in part, on the data obtained from the fuel sensor and data indicative of weather conditions (e.g., temperature, humidity, wind speed, etc.) for an environment (e.g., city, state, country) in which the space is located. The one or more computing devices may be configured to determine whether fuel consumption of the furnace is consistent with the weather conditions for the environment. For example, in some implementations, the data indicative of weather conditions for the environment in which the space is located can indicate that the external temperature (e.g., outside temperature) is about 60° F. Furthermore, the data obtained from the fuel sensor may indicate the furnace is running continuously (e.g., without stopping). In some cases, this is due to a fault condition associated with one or more components (e.g., a valve) of the heating system. For example, the valve may be stuck in an open position so that the furnace is needlessly burning fuel. As will be discussed below in more detail, in such an instance, the one or more computing devices may be configured to generate a notification associated with implementing an adjustment to the valve.

In some implementations, the notification can prompt a user (e.g., homeowner, landlord, etc.) to perform a maintenance action on the furnace. For example, the notification may be an audible notification (e.g., phone call) and/or a visual notification (e.g., text message, email, etc.) provided to a user device associated with one or more users. As discussed above, in some implementations, the valve can be stuck in the second position (e.g., open) so that the furnace is needlessly burning fuel. In such implementations, the notification may prompt the user to perform a maintenance action on the valve. More specifically, the maintenance action may be associated with repairing the valve or replacing the valve.

In some implementations, the one or more computing devices can determine a setpoint temperature associated with a thermostat of the heating system needs to be adjusted based, at least in part, on the data obtained from the fuel sensor. In such implementations, the one or more computing devices can be configured to provide one or more control signals associated with adjusting (e.g., increasing, decreasing) the setpoint temperature of the thermostat. In alternative implementations the one or more computing devices may determine the setpoint temperature needs to be adjusted based, at least in part, on the data obtained from the fuel sensor and at least one of the data obtained from the plurality of temperature sensors and the data indicative of weather conditions associated with the environment in which the space is located.

The system of the present disclosure provides numerous technical benefits. For instance, the system is configured to provide a notification to prompt a user (e.g., homeowner, technician, etc.) to refill the fuel supply when the data obtained via fuel sensor indicates the amount of fuel remaining in the fuel supply is less than a predetermined amount. In this manner, the system may prompt the user to refill the fuel supply before the fuel supply runs out of fuel. Furthermore, the plurality of temperature sensors that are separate from the thermostat and distributed throughout the space allows the system to detect variations in temperature across the different zones (e.g., story, room) of the space. In this manner, the system may more accurately determine whether operation of the heating system needs to be adjusted based, at least in part, on the data obtained from the fuel sensor and the data obtained from plurality of temperature sensors.

As used herein, the term “about” when used in conjunction with a numerical value refers to a range of values within 20% of the stated numerical value.

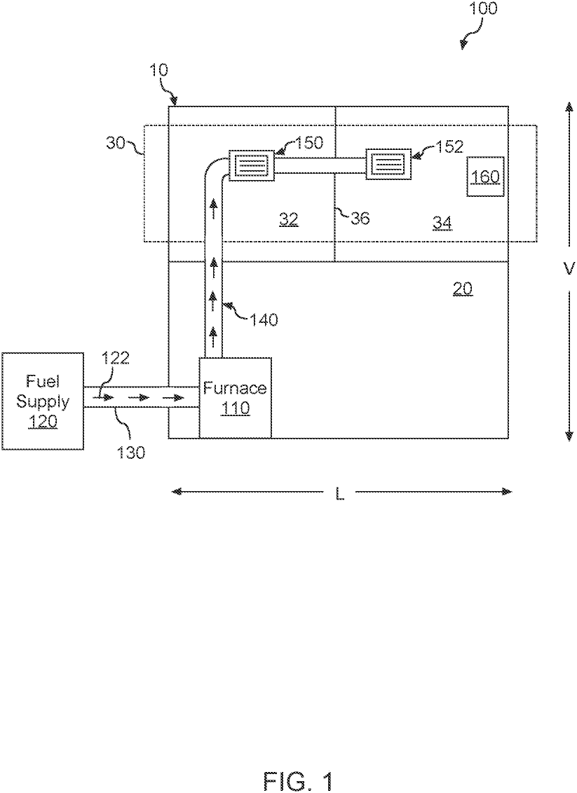

Referring now to the FIGS., FIG. 1 depicts an example heating system 100 for a building 10 (e.g., residential home, office, etc.). The building 10 may define a vertical direction V and a lateral direction L. As shown, in some implementations, the interior of the building 10 may be divided into a first level or first story 20 and a second level or second story 30 that is spaced apart from the first story 20 along the vertical direction V. For instance, the first story 20 may be a basement, and the second story 30 may be a living area. In some implementations, the second story 30 can be divided into a first room or first space 32 (e.g., kitchen) and a second room or second space 34 (e.g., bedroom, laundry room, living room, etc.) via a wall 36 that extends along at least the vertical direction V. It should be appreciated, however, the interior of the building 10 can have any suitable layout. It should also be appreciated that the building 10 can include more or fewer stories. For instance, in some implementations, the building 10 can be a single story residential home.

The heating system 100 may include a furnace 110 configured to heat the interior of the building 10. As shown, in some implementations, the furnace 110 can be disposed within the interior of the building 10. In this manner, the furnace 110 can be insulated from weather conditions (e.g., heat, cold, rain, wind, snow, etc.) associated with an environment in which the building 10 is located. It should be appreciated that, in some implementations, the furnace 110 can be positioned outside (e.g., not within the interior) of the building 10.

As shown, the furnace 110 may be in fluid communication with a fuel supply 120 via a conduit 130. In such cases, the fuel supply 120 can provide fuel 122 (e.g., natural gas, propane, liquified petroleum gas (LPG), oil, etc.) to the furnace 110 via the conduit 130. It should also be appreciated that the fuel supply 120 may include any suitable source configured to provide the flow of fuel 122 to the furnace 110. For instance, in some implementations, the fuel supply 120 can include one or more tanks filled with the fuel 122. In alternative implementations, the fuel supply 120 may be a gas supply line provided by a third-party (e.g., city, municipality). Operation of the furnace 110 will now be discussed below in more detail.

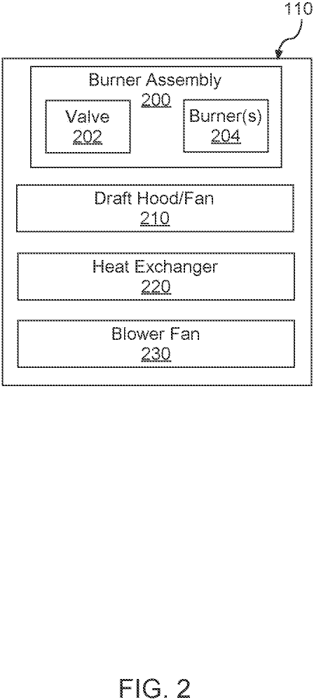

Referring now to FIG. 2, components of the furnace 110 are provided according to example embodiments of the present disclosure. As shown, the furnace 110 may include a burner assembly 200. The burner assembly 200 may include a valve 202 and one or more burners 204. The valve 202 may be movable between at least a first position (e.g., closed) and a second position (e.g., open) to selectively permit fuel 122 from the fuel supply 120 to be provided to the one or more burners 204. For instance, the fuel 122 may not be provided to the one or more burners 204 when the valve 202 is in the first position (e.g., closed). However, the fuel 122 may be provided to the one or more burners 204 when the valve 202 is in the second position (e.g., open).

It should be appreciated that the valve 202 may include any suitable type of valve configured to selectively permit the flow of fuel 122 to be provided to the furnace 110. For instance, in some implementations, the valve 202 can be a solenoid valve or any other suitable type of electromechanically operated valve.

In some implementations, the furnace 110 can include a draft hood or fan 210 operable to draw air into the one or more burners 204 of the burner assembly 200. When the heating system 100 calls for heat, the valve 202 is actuated to the second position (e.g., open) to allow the fuel 122 to flow into the one or more burners 204 such that the fuel 122 mixes with the air. Furthermore, the one or more burners 204 ignite the mixture of fuel 122 and air to produce a flame that is directed towards a heat exchanger 220 of the furnace 110. In this manner, the heat exchanger 220 is heated by combustion gas that are formed when the one or more burners 204 ignite the mixture of fuel 122 and air. In some implementations, the heat exchanger 220 can include a plurality of tubes positioned such that the combustion gas flows through the interior of the tubes. In this manner, the plurality of tubes can be heated by the combustion gas. As will be discussed below, in more detail, air directed across the heat exchanger 220 while the heat exchanger 220 is being heated may be used to heat the interior of the building 10.

In some implementations, the furnace 110 can include a blower fan 230 operable to direct (e.g., blow) air across the heat exchanger 220 while the heat exchanger 220 is being heated due, at least in part, to the combustion gases flowing therethrough. In this manner, the air blowing across the heat exchanger 220 may be heated. Furthermore, the heated air (e.g., denoted by arrows) may be distributed throughout the interior of the building 10 via one or more ducts 140. In this manner, the furnace 110 of the heating system 100 (FIG. 1) may be operated to heat the interior of the building 10 as desired.

In some implementations, the heated air (e.g., denoted by arrows) can be expelled into the interior of the building 10 via one or more registers. For instance, in some implementations, a first register 150 can be disposed within the first space 32 of the second story 30. In this manner, the heated air may be expelled into the first space 32 via the first register 150. Alternatively or additionally, a second register 152 may be disposed within the second space 34 of the second story 30. In this manner, the heated air may be expelled into the second space 34 via the second register 152. It should be appreciated that, in alternative implementations, more or fewer registers can be used in the first space 32 and the second space 34.

In some implementations, the heating system 100 can include a thermostat 160 configured to control operation of the furnace 110. For instance, the thermostat 160 may include one or more input devices (not shown) that can be manipulated by a user to adjust a setpoint temperature for the interior of the building 10. Examples of the one or more input devices may include, without limitation, knobs, switches, levers, touch-screen, or any other suitable type of input device operable to receive a user-input associated with adjusting the setpoint temperature. In some implementations, the thermostat 160 can be configured to monitor a temperature of the interior of the building 10 and provide one or more control signals associated with operating the furnace 110 when the temperature of the interior falls below the setpoint temperature by a predetermined amount.

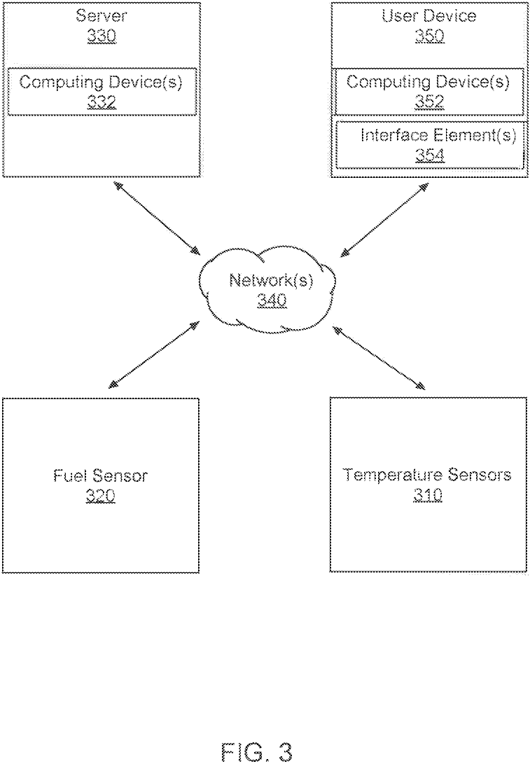

Referring now to FIG. 3, a system 300 for monitoring operation of a heating system (e.g., the heating system 100 of FIG. 1) is provided according to example embodiments of the present disclosure. As shown, the system 300 may include a plurality of temperature sensors 310. It should be understood that the plurality of temperature sensors 310 are separate from the thermostat 160 of the heating system 100. Therefore, the plurality of temperature sensors 310 may, as will be discussed below in more detail, be dispersed throughout the interior of the building 10.

In some implementations, one or more of the plurality of temperature sensors 310 can be disposed within the first story 20 (FIG. 1) of the building 10. In this manner, the system 300 may obtain data indicative of a temperature within the first story 20 of the building 10. Alternatively or additionally, one or more of the plurality of temperature sensors 310 may be disposed within the second story 30 of the building 10. For example, a temperature sensor may be disposed within the first space 32 of the second story 30. Alternatively or additionally, a temperature sensor may be disposed within the second space 34 of the second story 30. In this manner, the system 300 may obtain data indicative of a temperature at one or more locations (e.g., first space 32, second space 34) of the second story 30. As will be discussed below in more detail, variations in the temperature at one or locations or zones (e.g., story, room, space, etc.) within the interior of the building 10 during the period of time may be detected based, at least in part, on the data (e.g., temperature readings) obtained from the plurality of temperature sensors 310.

In some implementations, the system 300 can include a fuel sensor 320. The fuel sensor 320 may be configured to obtain data indicative of an amount of fuel in the fuel supply 120. For instance, in some implementations, the fuel supply 120 can be a tank, and the fuel sensor 320 can be configured to obtain data indicative of the amount of fuel in the tank. In this manner, the amount of fuel remaining in the tank may be determined based, at least in part, on the data obtained via the fuel sensor 320. It should be appreciated that the fuel sensor 320 may include any suitable type of sensor operable to detect the amount of fuel in the tank. For instance, in some implementations, the fuel sensor 320 can be an ultrasonic sensor.

The system 300 may include one or more servers 330 configured to communicate with the sensors (e.g., plurality of temperature sensors 310 and fuel sensor 320) over one or more networks 340. In this manner, the server 330 may obtain data (e.g., temperature readings, fuel level readings) from the temperature sensors 310, and fuel sensor 320. It should be appreciated that the one or more networks 340 may include any suitable type of network, such as a local area network (e.g., intranet), a wide area network (e.g., internet), a low power wireless network (e.g., Bluetooth Low Energy (BLE), Zigbee, etc.), cellular network, or some combination thereof and may include any number of wired or wireless links. In general, communication over the one or more networks 340 may be implemented via any type of wired or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Example communication protocols include, for instance, Bluetooth low energy, Bluetooth mesh networking, near-field communication, Wi-Fi (e.g., IEEE, 802.11), Wi-Fi Direct (for peer-to-peer communication), Z-Wave, Zigbee, Halow, cellular communication, LTE, LoRa, or low-power wide area networking. Other suitable wired and/or wireless communication protocols can be used without deviating from the scope of the present disclosure.

In some implementations, the system 300 can include one or more wireless access points (not shown) configured to facilitate communication between the server 330 and the sensors (e.g., temperature sensors 310 and fuel sensor 320). For example, the one or more wireless access points may include a router configured to obtain data from the temperature sensors 310 and fuel sensor 320 and communicate the data to the server 330. It should be appreciated that the wireless access points may include any suitable device configured to facilitate communication between the server 330 and the sensors (e.g., temperature sensors 310 and fuel sensor 320).

In some implementations, the server 330 can include one or more computing devices 332. The one or more computing devices 332 may be configured to process data obtained from the temperature sensors 310 and/or the fuel sensor 320. For instance, the one or more computing devices 332 may be configured to generate a graphical representation of a measured temperature at one or more zones (e.g., story, room, space, etc.) within the interior of the building 10 for a period of time based, at least in part on the data (e.g., temperature readings) obtained from the plurality of temperature sensors 310 which, as discussed above, are dispersed throughout the interior of the building 10. Alternative and/or additionally, the one or more computing devices 332 may be configured to generate a graphical representation of fuel consumption of the furnace 110 for a period of time based, at least in part, on the data (e.g., fuel level readings) obtained from the fuel sensor 320.

Although the server 330 of the system 300 in FIG. 3 is depicted as being a stand-alone component, it should be understood that, in some implementations, the server 330 can be integrated with one or more existing components of the heating system 100 (FIG. 1). For instance, in some implementations, the one or more computing devices 332 of the server 330 can be included onboard the thermostat 160 (FIG. 1) of the heating system 100. In this manner, the data obtained from the temperature sensors 310 and/or the fuel sensor 320 may be processed locally at the thermostat 160.

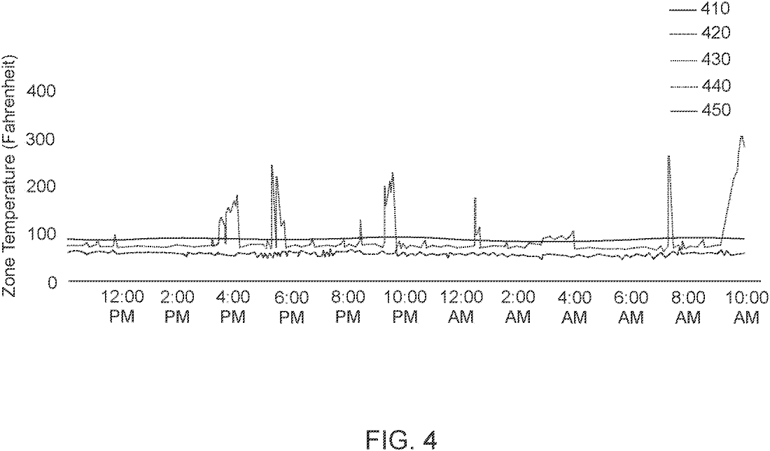

Referring now FIG. 4, a graphical representation of a temperature measured for a period of time at one or more zones within a space heated by a heating system is provided according to example embodiments to the present disclosure. As shown, the graph plots the temperate (e.g., denoted along the vertical axis in degrees Fahrenheit) as function of time (denoted along the horizontal axis in hours). The graph depicts five separate curves indicative of the measured temperature at five different zones (e.g., stories, rooms, etc.) of the space. As will be discussed below, each of the curves is generated based, at least in part, on data obtained from one of the temperature sensors 310 of the system 300 discussed above with reference to FIG. 3.

Curve 410 depicts a temperature at a first zone over the period of time (e.g., 12 hours) based, at least in part, on data (e.g., temperature readings) obtained from a first temperature sensor positioned within the first zone. Curve 420 depicts a temperature at a second zone over the period of time based, at least in part, on data obtained from a second temperature sensor positioned within the second zone. Curve 430 depicts a temperature at a third zone over the period of time based, at least in part, on the data obtained from a third temperature sensor positioned within the third zone. Curve 440 depicts a temperature at a fourth zone over the period of time based, at least in part, on the data obtained from a fourth temperature sensor positioned within the fourth zone. Curve 450 depicts a temperature at a fifth zone over the period of time based, at least in part, on the data obtained form a fifth temperature sensor positioned within the fifth zone. It should be appreciated that the zones (e.g., first zone, second zone, third zone, fourth zone, fifth zone) are distinct from one another.

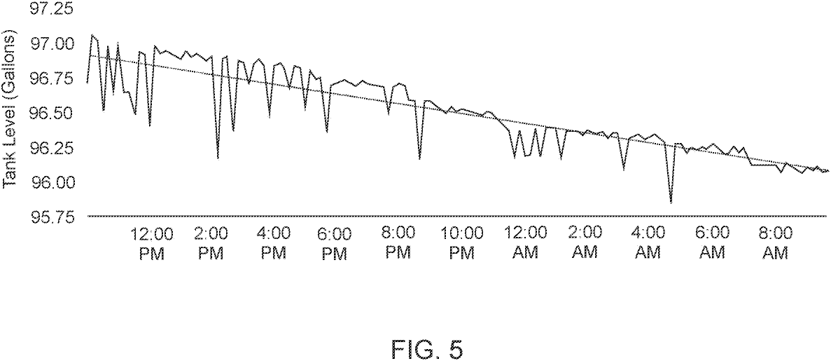

Referring now to FIG. 5, a graphical representation of fuel consumption of a furnace of a heating system (e.g., heating system 100 of FIG. 1) for a period of time is provided according to example embodiments of the present disclosure. As shown, the graph plots fuel consumption (e.g., denoted along the vertical axis in gallons) as a function of time (e.g., denoted along the horizontal axis in hours). In this manner, the graph illustrates a rate at which the furnace is consuming fuel over the period of time.

Referring again to FIG. 3, the system 300 may include one or more user devices 350 (e.g., smartphone, tablet, laptop, etc.). As shown, the one or more user devices 350 may include one or more computing devices 352. In some implementations, the one or more user devices 350 can include one or more interface elements 354 (e.g., buttons, keyboard, mouse, touchscreen display). In some implementations, a user can interact with the one or more interface elements 354 to display the graphical representations of temperature zones (FIG. 4) and/or fuel consumption (FIG. 5) on a display 356 of the one or more user devices 350. As will be discussed below in more detail, the system 300 may provide notifications based, at least in part, on the data obtained from the temperature sensors 310 and/or the fuel sensor 320.

In some implementations, the one or more computing devices 332 can be configured to determine whether operation of the heating system 100 needs to be adjusted based, at least in part, on the data obtained from the fuel sensor 320 for the period of time. For instance, if the data obtained from the fuel sensor for the period of time indicates that the amount of fuel within the fuel supply is constantly decreasing, the one or more computing devices 332 may be configured to determine operation of the heating system 100 needs to be adjusted.

In some implementations, the one or more computing devices 332 can be configured to determine whether operation of the heating system 100 needs to be adjusted based, at least in part, on the data obtained from the fuel sensor 320 for the period of time and the data obtained from the temperature sensors 310 for the period of time. For instance, in some implementations, the data obtained from the fuel sensor 320 can indicate that the amount of fuel within the fuel supply 120 (FIG. 1) is constantly decreasing. However, the data obtained from the plurality of temperature sensors 310 may indicate that the temperature of one or more zones within the space is not increasing as a result of the furnace 110 (FIG. 1) heating the space. For instance, data obtained from a first temperature sensor positioned within a first zone (e.g., first story) of the space may indicate a temperature of the first zone is increasing (e.g., getting warmer). However, data obtained from a second temperature sensor positioned within a second zone (e.g., second story) of the space may indicate a temperature of the second zone is either staying the same (e.g., not increasing) or decreasing (e.g., getting cooler). In such instances, the one or more computing devices 332 may be configured to determine operation of the heating system 100 needs to be adjusted.

In some implementations, the one or more computing devices 332 of the server 330 can be configured to obtain data indicative of weather conditions (e.g., temperature, humidity, wind speed, etc.) for an environment (e.g., city, state, country) in which the building 10 (FIG. 1) is located. Additionally, the one or more computing devices 332 may be configured to determine whether fuel consumption of the furnace 110 is consistent with the weather conditions for the environment. For example, in some implementations, the data indicative of weather conditions for the environment in which the building 10 is located may indicate that the outside temperature (e.g., temperature of the environment) is about 60° F. Furthermore, the data obtained from the fuel sensor 320 may indicate the furnace 110 is running continuously (e.g., without stopping). This may be due to a fault condition associated with one or more components (e.g., the valve 202) of the furnace 110. For example, the valve 202 may be stuck in the second position (e.g., open) so that the furnace 110 is needlessly burning fuel 122. As will be discussed below in more detail, the one or more computing devices 332 may be configured to provide a notification to indicate the furnace 110 is operating in a manner that is inconsistent with the weather conditions for the environment.

In some implementations, the notification can prompt a user (e.g., homeowner, landlord, etc.) to perform a maintenance action on the furnace 110. For example, the notification can be an audible notification (e.g., phone call) and/or a visual notification (e.g., text message, email, etc.) provided to the one or more user devices 350. As discussed above, in some implementations, the valve 202 can be stuck in the second position (e.g., open) so that the furnace 110 is needlessly burning fuel 122. In such implementations, the notification may prompt the user to perform a maintenance action on the valve 202. More specifically, the maintenance action may be associated with repairing the valve 202 or replacing the valve 202.

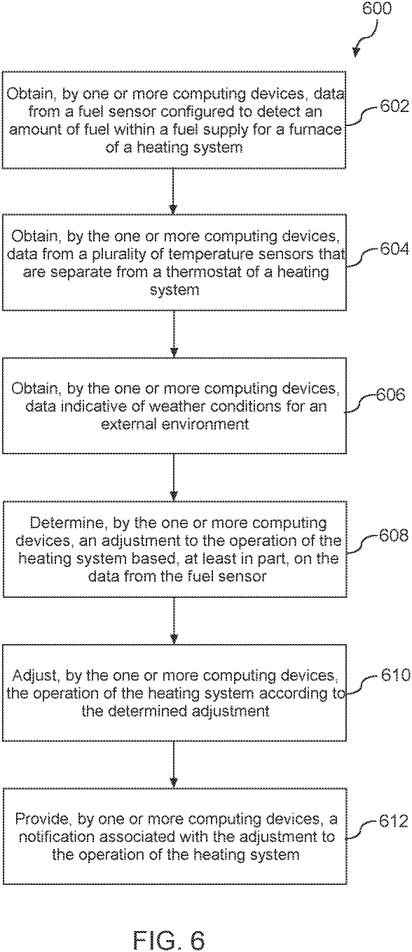

Referring now to FIG. 6, another flow diagram of a method 600 for monitoring operation of a heating system for a space is provided according to example embodiments of the present disclosure. It should be appreciated that the method 600 can be implemented using the system discussed above with reference to FIG. 6. FIG. 6 depicts steps performed in a particular order for purposes of illustration and discussion. Those of ordinary skill in the art, using the disclosures provided herein, will understand that various steps of the method 600 may be adapted, modified, rearranged, performed simultaneously or modified in various ways without deviating from the scope of the present disclosure.

At (602), the method 600 may include obtaining, by one or more computing devices, data from a fuel sensor for a period of time. As discussed above, the fuel sensor may be configured to detect an amount of fuel within a fuel supply for a furnace of the heating system. In some implementations, the period of time can range from about 12 hours to about 24 hours.

At (604), the method 600 may include obtaining, by the one or more computing devices, data from a plurality of temperature sensors over the period of time. As discussed above, each of the plurality of sensors can be positioned within a distinct zone (e.g., story, room, etc.) of the space. In this manner, temperature variations between the different zones of the space may be detected.

At (606), the method 600 may include obtaining, by the one or more computing devices, data indicative of weather conditions associated with an external environment in which the space is located. Examples of weather conditions can include, without limitation, temperature, humidity, wind speed, or any other suitable parameter indicative of the weather occurring in the external environment.

At (608), the method 600 may include determining, by the one or more computing devices, an adjustment to the operation of the heating system based, at least in part, on the data obtained from the fuel sensor over the period of time. For instance, if the data obtained from the fuel sensor over the period of time indicates that the amount of fuel within the fuel supply is constantly decreasing, the adjustment may be associated with shutting down the furnace of the heating system. Additionally, the method 600 may proceed to (610) such that the operation of the heating system can be adjusted according to the adjustment.

In some implementations, the one or more computing devices can be configured to determine the adjustment to the operation of the heating system based, at least in part, on the data obtained at (602) and at least one of the data obtained at (604) and the data obtained at (606). For instance, in some implementations, the one or more computing devices can be configured to determine an adjustment to the operation of the heating system based, at least in part, on the data obtained from the fuel sensor at (602) and the data obtained from the plurality of temperature sensors at (604).

As an example, the data obtained from the fuel sensor at (602) may indicate that the amount of fuel within the fuel supply is constantly decreasing. However, the data obtained at (604) may indicate that the temperature of one or more zones within the space is not increasing as a result of the furnace heating the space. For instance, data obtained at (604) can indicate a temperature of a first zone (e.g., first story) in which the furnace is located is increasing (e.g., getting warmer). However, the data obtained at (604) may also indicate that a temperature of a second zone (e.g., second story) positioned above the first zone is either staying the same (e.g., not increasing) or decreasing. In such instances, the adjustment to the operation of the heating system may include performing a maintenance action (e.g., repair or replace) on one or more components of the heating system. Furthermore, the method 600 may proceed to (610).

As another example, the data obtained from the fuel sensor at (602) can indicate the amount of fuel within the fuel supply is constantly decreasing during the period of time. However, the data obtained at (606) can indicate that the outside temperature (e.g., temperature of the external environment) during the period of time is above a threshold temperature (e.g., above about 60° F.) at which the space does not need to be heated via the heating system. In such implementations, the method 600 may proceed to (610) to adjust the operation of the heating system according to the adjustment.

At (610), the method 600 may include adjusting, by the one or more computing devices, operation of the heating system according to the adjustment determined at (608). For instance, in some implementations, the adjustment can be associated with shutting down the furnace of the heating system. In such implementations, adjusting operation of the heating system according to the adjustment comprises providing, by the one or more computing devices, one or more control signals associated with shutting down the furnace. In particular, the one or more control signals may be provided to the thermostat of the heating system which, as discussed above, is configured to control operation of the furnace.

At (612), the method 600 may include providing a notification to indicate operation of the heating system needs to be adjusted. In some implementations, the notification can indicate a maintenance action needs to be performed on one or more components of the heating system to implement the adjustment. For example, the notification may indicate the valve of the furnace needs to be repaired or replaced. In some implementations, the notification can be provided to the one or more user devices having a display screen. In such implementations, the notification may include at least one of an audible notification (e.g., automated call) and a visual notification (e.g., text message, email).

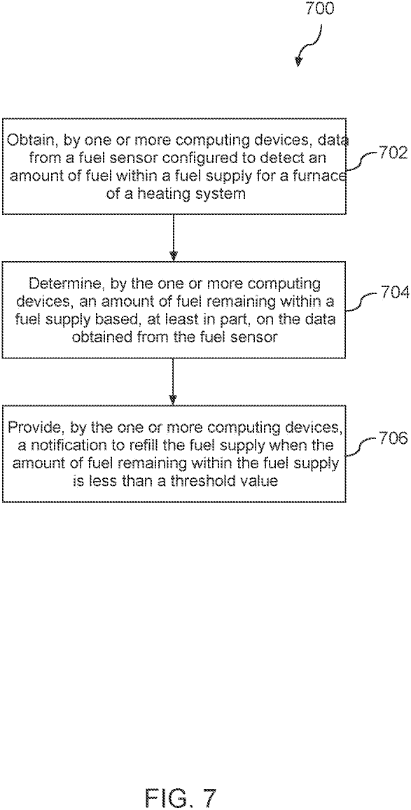

Referring now to FIG. 7, a flow diagram of a method 700 for monitoring operation of a heating system for a space is provided according to example embodiments of the present disclosure. It should be appreciated that the method 700 may be implemented using the system discussed above with reference to FIG. 3. FIG. 7 depicts steps performed in a particular order for purposes of illustration and discussion. Those of ordinary skill in the art, using the disclosures provided herein, will understand that various steps of the method 700 may be adapted, modified, rearranged, performed simultaneously or modified in various ways without deviating from the scope of the present disclosure.

At (702), the method 700 may include obtaining, by one or more computing devices, data from a fuel sensor configured to detect an amount of fuel within a fuel supply for a furnace of the heating system. In some implementations, the fuel sensor can be an ultrasonic sensor. Alternatively or additionally, the fuel supply may include a tank configured to accommodate the fuel to be burned by the furnace to heat the space.

At (704), the method 700 may include determining, by the one or more computing devices, an amount of fuel remaining in the fuel supply based, at least in part, on the data obtained from the fuel sensor at (702). At (706), the method may include determining, by the one or more computing devices, whether the amount of fuel remaining in the fuel supply is less than a threshold amount (e.g., less than about 25% full). When the one or more computing devices determining the amount of fuel remaining in the fuel supply is greater than the threshold amount, the method 700 ends or reverts to (702). Conversely, the method 700 proceeds to (706) when the one or more computing devices determine the amount of fuel remaining in the fuel supply is less than the threshold amount.

At (706), the method 700 may include providing, by the one or more computing devices, a notification to prompt a user to perform a maintenance action on the fuel supply. For instance, in some implementations, the maintenance action can be associated with filling the fuel supply with fuel until the amount of fuel within the fuel supply is greater than the threshold amount. In some implementations, the notification to prompt the user to perform the maintenance action can be provided to a user device (e.g., smartphone, tablet, laptop, etc.) having a display screen. In such implementations, the notification may include an audible notification (e.g., automated phone call), a visual notification (e.g., text message, e-mail), or both.

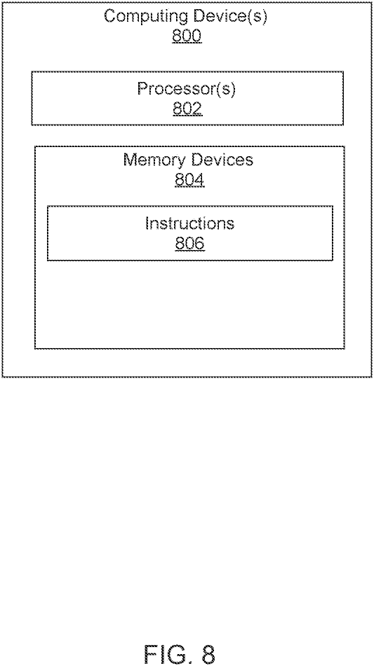

FIG. 8 illustrates one embodiment of suitable components of a computing device 800. It should be appreciated that the computing device 800 can correspond to the one or more computing devices 332, 352 discussed above with reference to the system 300 of FIG. 3. As shown, the computing device 800 may include one or more processors 802 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits.

As shown, the computing device 800 may include a memory device 804. Examples of the memory device 804 include computer-readable media including, but not limited to, non-transitory computer-readable media, such as RAM, ROM, hard drives, flash drives, or other suitable memory devices. The memory device 804 may store information accessible by the processor(s) 802, including computer-readable instructions 806 that may be executable by the processor(s) 802. The computer-readable instructions 806 may be any set of instructions that, when executed by the processor(s) 802, cause the processor(s) 802 to perform operations. The computer-readable instructions 806 may be software written in any suitable programming language or can be implemented in hardware.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for monitoring operation of a heating system configured to heat a space, the method comprising:
obtaining, by one or more computing devices, data from a fuel sensor for a period of time, the fuel sensor configured to detect an amount of fuel within a fuel supply for a furnace of the heating system;
determining, by the one or more computing devices, an adjustment to the operation of the heating system based, at least in part, on the data obtained from the fuel sensor; and
adjusting, by the one or more computing devices, the operation of the heating system according to the adjustment.

2. The method of claim 1, wherein when the data obtained from the fuel sensor indicates the amount of fuel within the fuel supply is constantly decreasing during the period of time, the adjustment comprises shutting down the heating system.

3. The method of claims 1 and 2 , wherein the period of time ranges from about 12 hours to about 24 hours.

4. The method of any of claims 1-3, wherein the method further comprises:
obtaining, by the one or more computing devices, data from a plurality of temperature sensors for the period of time, each of the plurality of temperature sensors disposed within a different zone of the space.

5. The method of any of claims 1-4wherein determining the adjustment to the operation of the heating system comprises determining, by the one or more computing devices, the adjustment based, at least in part, on the data obtained from the fuel sensor and the data obtained from the plurality of temperature sensors.

6. The method of any of claims 1-5wherein when the data obtained from the fuel sensor indicates the amount of fuel within the fuel supply is constantly decreasing and the data obtained from the plurality of temperature sensors indicates a temperature at one or more zones of the space stays constant or decreases, the adjustment comprises performing a maintenance action on one or more components of the heating system.

7. The method of any of claims 1-6, wherein the adjustment comprises repairing or replacing the one or more components.

8. The method of any of claims 1-7, wherein the method further comprises:
providing, by the one or more computing devices, a notification to indicate the adjustment being made to the heating system.

9. The method of any of claims 1-8, wherein the notification comprises at least one of an audible notification and a visual notification.

10. The method of any of claims 1-9, wherein the method further comprises:
obtaining, by the one or more computing devices, data indicative of weather conditions associated with an external environment in which the space is located.

11. The method of any of claims 1-10, wherein determining the adjustment to the operation of the heating system comprises determining, by the one or more computing devices, the adjustment based, at least in part, on the data obtained from the fuel sensor and the data indicative of weather conditions associated with the external environment in which the space is located.

12. The method of any of claims 1-11, further comprising:
determining, by the one or more computing devices, whether the amount of fuel in the fuel supply is less than threshold amount based, at least in part, on the data obtained from the fuel sensor;
responsive to determining the amount of fuel remaining in the fuel supply is less than a threshold amount, providing, by the one or more computing devices, a notification to prompt a user to perform a maintenance action on the fuel supply.

13. The method of any of claims 1-12, wherein the maintenance action is associated with filling the fuel supply with fuel until the amount of fuel within the fuel supply is greater than the threshold amount.

14. The method of any of claims 1-13, wherein providing the notification comprises providing, by the one or more computing devices, the notification to a user device having a display screen.

15. The method of any of claims 1-14, wherein the notification comprises at least one of an audible notification and a visual notification.

16. The method of any of claims 1-15, wherein the fuel supply comprises a tank.

17. The method of any of claims 1-16, wherein the fuel sensor comprises an ultrasonic sensor.

18. A system for monitoring operation of a heating system for a space, the system comprising:
a plurality of temperature sensors that are separate from a thermostat of the heating system, each of the plurality of temperature sensors disposed within a different zone of the space;
a fuel sensor configured to detect an amount of fuel within a fuel supply for the heating system; and
one or more computing devices configured to:
obtain data from the fuel sensor for a period of time, the data indicative of the amount of fuel within the fuel supply;
determine an adjustment to the operation of the heating system based, at least in part, on the data obtained from the fuel sensor; and
adjust the operation of the heating system according to the adjustment.

19. The system of claim 18, wherein when the data indicates the amount of fuel within the fuel supply is constantly decreasing during the period of time, the adjustment to the operation of the heating system is associated with shutting down a furnace of the heating system.

20. The system of any of claims 1-19, wherein the one or more computing devices are further configured to:
obtain data from the plurality of temperature sensors for the period of time.

21. The system of any of claims 1-20, wherein the one or more computing devices are further configured to:
determine the adjustment to the heating system based, at least in part, on the data obtained from the fuel sensor and the data obtained from the plurality of temperature sensors.

22. The system of any of claims 1-21, wherein when the data obtained from the fuel sensor indicates the amount of fuel within the fuel supply is constantly decreasing and the data obtained from the plurality of temperature sensors indicates a temperature at one or more zones of the space stays constant or decreases, the adjustment comprises performing a maintenance action on one or more components of the heating system.

23. The system of any of claims 1-22, wherein the fuel sensor comprises an ultrasonic sensor.

24. The system of any of claims 1-23, wherein the period of time ranges from about 12 hours to about 24 hours.

25. A system according to example embodiments of the present disclosure.

26. A method according to example embodiments of the present disclosure.
